(19) United States
(12) Patent Application Publication
(10) Pub. No.: US 2002/0092481 A1
(43) Pub. Date: Jul. 18, 2002

(54) Method and apparatus for confining animals

(76) Inventor: David Neal Spooner, Iron City, GA (US)

Correspondence Address: Brian D. Bellamy, P.O. Box 1997, Thomasville, GA, 31799-1997, US

(21) Appl. No.: 10/039,782

(22) Filed: Nov. 9, 2001

Related U.S. Application Data
(60) Provisional application No. 60/261,455, filed on Jan. 12, 2001.

(51) Int. Cl. A01K 15/04

(52) U.S. Cl. 119/908

(57) ABSTRACT

A method and apparatus for confining animals or livestock and preventing their traverse through a gate. Mats are provided having an insulated substrate holding an electrically conductive medium embedded therein. A power source supplies electrical current to the conductive medium. When the power source is activated, the mats may convey a shock to an animal. The mats are located in a gate passage so as to enable normal operation of the gate while preventing the traverse of livestock or animals within the gated area.

### PRIORITY CLAIM

The present application claims benefit of U.S. Provisional Application No. 60/261455 filed on Jan. 12, 2001.

### BACKGROUND OF THE INVENTION

The present invention relates to a method and apparatus for confining livestock in a fenced area having a gate, and in particular to the confinement of livestock or animals while the gate is open using a mat constructed to provide an electric charge to the animal.

Livestock, such as cattle, pigs, horses, goats, emus, ostrich, and lama, are generally raised in large pastures that are fenced. Likewise, zoos, animal petting areas, and parks often contain livestock and other animals within fenced areas.

In many cases these pastures or fenced areas for confining animals also contain or are adjacent to agricultural crops, homes, recreational areas and other surroundings frequented by humans. In each case, farmers, residents or visitors encounter gates for ingress and egress. Usually, a gate is encountered while the person is operating a vehicle, and each time a gate is encountered, the person performs the time consuming task of getting out of their vehicle, opening the gate, getting back into their vehicle and driving through the gate, getting out of their vehicle and closing the gate, and then getting back into their vehicle. Passage can become even more difficult for a farmer burdened by the use of large farming equipment and frequent passage. Thus, it is not surprising that the gates that confine livestock are often left open on purpose or by accident, but with the unfortunate result that the livestock confined within the fenced area are able to escape through the open gate.

The problems caused by gates to busy farmers can become very significant as time and energy is wasted managing the operation of these gates. Further, when livestock escape because the gate is inadvertently left open or blown open by wind, a farmer can spend entire days rounding up cattle or other livestock. Thus, a need exists to provide a method of leaving a gate open for passage of humans without allowing livestock or animals confined by the gate to escape.

Push gates are known as a means for making typical gate passage more convenient. However, these push gates are more cumbersome than an open gate and are especially inconvenient to use with some farm equipment. Further, push gates may be blown open by wind and become ineffective as a confining gate. Therefore, it would be advantageous to maintain the confinement of livestock or animals even when a gate or push gate is completely open and itself ineffective for confinement.

The prior art does not disclose a method or apparatus for confining livestock when a gate is open that is suitable for most gates used in pastures or by vehicles. One prior art device provides a portable cattle guard having several rubber strips that are fastened between to 2×4 lumber causing the strips to be raised from the ground to present a walk through obstacle for cattle. The rubber strips are positioned between the posts on either side of a small gate. Because the rubber strips may sag or tear if driven over constantly by vehicles, this type of cattle guard is not effective for wide gates or driveways. Further, cattle are more prone to test this type of guard and eventually overcome the obstacle present by the raised rubber strips by ignoring or destroying them.

It is known to provide electric wire fence alone or in combination with a non-electrified fence for confinement of animals. Some other efforts have been made to use electricity to discourage animals from small localized areas such as garbage containers. For instance, U.S. Pat. No. 4,949,216 to Klaus Djukastein discloses an electric mat for discouraging small animals from a small area such as garbage cans, automobiles, and furniture. And, U.S. Pat. No. 4,274,123 to Thurmond J. Robers, Jr. discloses an electric mat for shocking and repelling animals from a garbage can. However, this prior art does not disclose a method using a mat capable of providing an electric shock for confining animals or livestock within a fenced area while leaving a gate to that area open.

The present invention is directed to overcoming the one or more of the problems discussed above.

### SUMMARY OF THE INVENTION

The present invention provides a method for using an insulated mat for carrying electric current in deterring livestock or animals from traversing through an open gate of an otherwise confined area. The invention provides a mat comprised of a non-conductive substrate material such as rubber or plastic and having conductive wiring for carrying an electric current. The mat has a width of three feet or more and is placed on the ground in the area between fences posts where a gate is provided. Thus, when the gate is open or removed, the mat covers a substantial portion of the space previously spanned by the gate.

When a gate is opened or when a switch is made, electric power is provided to the conductive wiring of the mat. Should a cow or horse or the like contact the mat, an electric shock is applied to the animal. Livestock or animals generally sense the danger of the mat and do not test it. However, any further testing will be deterred by the shock. The mat confines the animals by deterring their approach to the open gated area, while permitting the passage of humans by vehicle.

The mat does not require a ground since most animals to be deterred by the mat are large enough that they will ground themselves by having a portion of their body off of the mat. However, a switch may be provided where desired to causes a portion of the conductive wiring in the mat to be grounded.

The invention contemplates safe passage across the mat by humans on foot by situating the conductive wiring in grooves of the substrate and by providing a warning system and activation device.

### BRIEF DESCRIPTION OF THE DRAWINGS

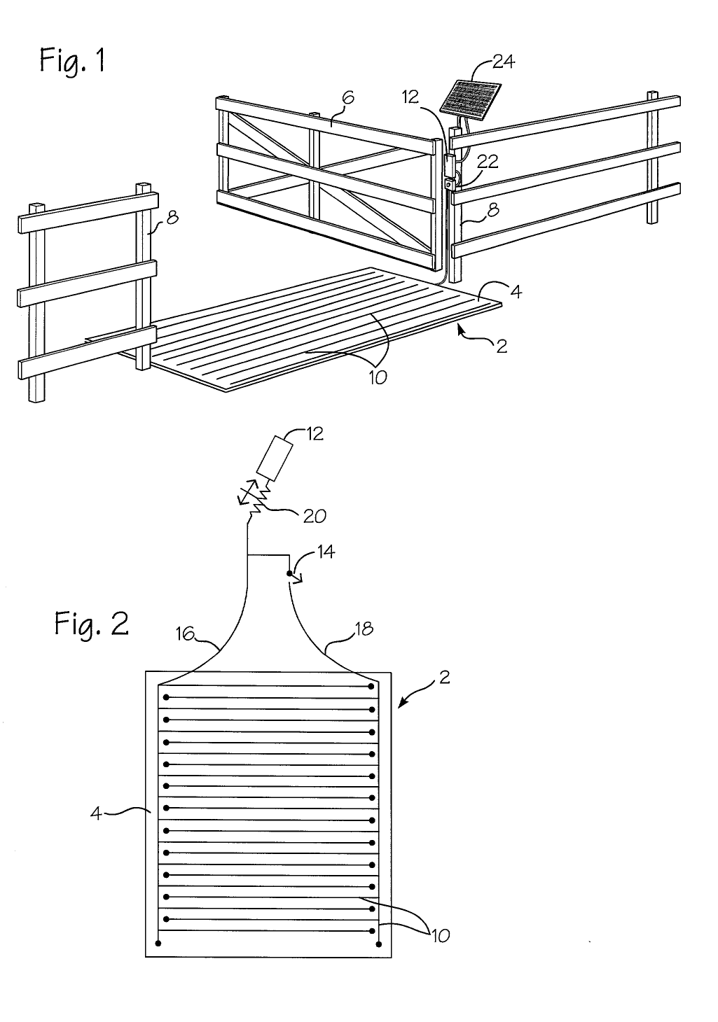

1. FIG. 1 is a perspective view of an embodiment of the apparatus and methodology in accordance with the present invention.

2. FIG. 2 is a schematic view of one embodiment of the mat disclosed herein in accordance with the invention.

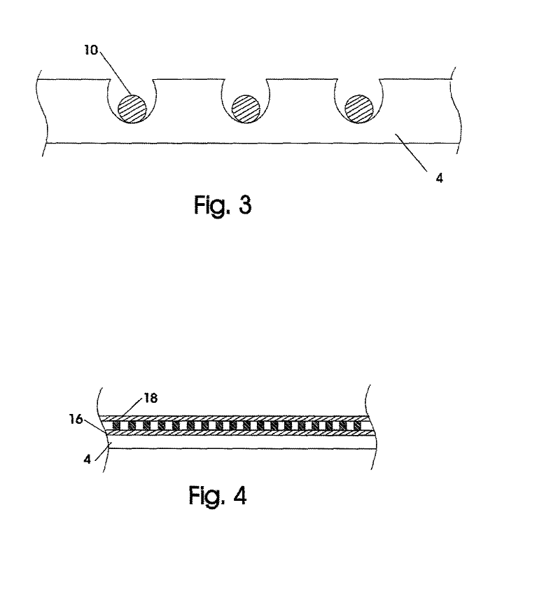

3. FIG. 3 is a partial cross-sectional view of an alternative embodiment of the mat disclosed herein taken along line 3-3 of FIG. 1.

4. FIG. 4 is a partial cross-sectional view of an alternative embodiment of the mat disclosed herein taken along line 4-4 of FIG. 2.

### DETAILED DESCRIPTION OF THE INVENTION

Referring to the drawings, a mat 2 is shown formed of a non-conductive insulated substrate material 4 such as rubber, flexible plastic, or other elastomeric material. As shown in FIG. 1, the mat 2 may be about three to four feet or more in width and rectangular. In the present invention, the mat 2 is set on the ground in the area spanned by a gate 6. Therefore, the mat 2 generally will be made to measure about as wide as the gate 6 to the area confined. A mat 2 four feet in width will be well-suited to most applications because four feet and eight feet are standard widths of many gates 6. Thus, one four foot mat 2 or a combination of two four foot mats 2 would be located in the path of a gate to span the breadth of typical gates. The actual shape and size of the mat 2 could vary to provide benefits such as easier crossing by humans. For instance, the mat 2 could be shaped triangular to provide narrow edges that are easy to step over or provide less contact by crossing vehicles. When the mat 2 is set on ground it can be anchored by its own weight or by other suitable means for attaching the mat 2 to the ground or to surrounding fixed objects such as fence posts 8.

As shown in FIG. 1 the mat contains an electrically conductive medium such as a conductive wire 10 or a plurality of conductive wire. The conductive medium 10 is attached to a power source 12 of electrical current for providing an electrical shock to livestock or animals. In the embodiment shown, the conductive medium 10 is situated onto the surface of the mat 2 in several recesses of the mat such that the conductive wire 10 is exposed on the mat 2, but is situated below the top surface of the mat. The grid of conductive wire 10 is generally parallel, but any layout of conductive wire 10 that will enable the conductive wire 10 to convey an electrical shock to an animal that steps on the mat 2 will accomplish the objects of the invention for confining animals or livestock.

The conductive wire 10 may be placed several inches apart because of large size of most animals or livestock the invention is concerned with. Most fenced areas, especially agriculturally related areas, are not constructed to confine smaller animals anyway. Thus, in many cases in which the methods of the invention will be used the design of mat 2 and conductive wiring 10 layout will not be concerned with any need to function with respect to small animals such as cats and dogs. This permits for additional consideration of the safety of the mat 2 and conductive wire 10 with respect to human interaction with mat 2. For example, the mat 2 may be grooved as shown in FIG. 3 with the conductive wire 10 set within the grooves and embedded below the upper surface of the mat 2. In this manner of construction, it may be contemplated that only heavier livestock versus humans will be sufficient weight to contact the conductive wire 10 and receive an electric shock that would otherwise be capable of causing injury to a human. Humans generally may receive an electric shock if directly standing on the mat without wearing insulating shoes. However, some additional safety may be provided by embedding the conductive medium so that a human contacting the mat 2 would be spatially separated from the conductive medium 10.

Further variations in the conductive wire grid may be made concerning the positive and negative charge of the wire. The illustration of FIG. 1 includes a switch 14 that when closed causes both wire 16 and wire 18 to be receive a positive charge. By operating the mat 2 with the switch 14 closed, a trespassing animal in a location with sufficient ground will complete the circuit and receive an electric shock without the need for wire 18 to act as a ground wire. In this case, the mat 2 could include conductive wire 10 made of a very inexpensive material such as a mesh wiring embedded within the mat 2. FIG. 3 illustrates an example of a conductive wire 10 embedded in grooves, but other methods of embedding the conductive wiring may be employed.

Additionally, by leaving the switch 14 open, the conductive wire 10 may include alternating positive and negative charges by allowing wire 16 to receive a positive charge from the power source 12 while grounding wire 18 to provide a ground wire. The alternating positive and negative wires 16 and 18 may be beneficial where sufficient ground is not possible such as on concrete, asphalt, or other types of pavement or dry soil. By grounding wire 18, an animal will not be required to be grounded off of the mat. Instead, the trespassing animal will complete the circuit between wire 16 and 18 and receive an electric shock.

The source of electric current may be provided by solar powered cells 24, batteries, or a local alternating current source. Solar powered cells 24 as shown in conjunction with the power source 12 of FIG. 1 may be especially advantageous because of the remote locations the mat 2 may be used in. Regardless of source, the electric current should provide a sufficient shock to provide an unpleasant sensation to a trespassing animal without injury. Electric current from power source 12 is activated by a power switch 22 provided conveniently on the gate's post 8 or nearby to turn on the current when needed so that the gate 6 can be left open. The power switch 22 may be operably connected to the gate 6 such that opening the gate 6 activates the switch 22.

In particular, the electric current should be regulated for safety. A variable resister 20 may be used to increase or decrease the amount of electrical voltage provided the mat 2. Initially, the electrical voltage may be increased to condition livestock for a period of time. Once the livestock are conditioned to the danger of the mat 2, the voltage may be reduced to increase the safety of the mat 2. Livestock are easily conditioned to respect the boundary set forth by the mat 2. In particular, livestock hesitate to walk on anything that is unfamiliar, and the mat 2 will not fit into the natural surroundings of the livestock. Further, livestock can smell and sense the danger of an electric mat. By increasing the awareness of the livestock to the mat 2, the mat's 2 safety and effectiveness can be improved.

Most humans would be wearing shoes should they come into personal contact with the mat 2 and would not receive any electric shock from the mat 2. Nonetheless, because of the natural tendencies of livestock, the electrical charge is not required to be very great. Further, the electric charge may be made pulsating so that a person would not be attracted to the mat 2 in the case they did receive a shock. To avoid such risk of any shock to a human, a warning device may be provided within the mat 2 itself or nearby that signifies the mat 2 is electrically charged by broadcasting a light or sound. Said warning system would be activated by the same mechanism as the provision of electric current to the mat 2 to avoid fault.

An alternative or additional safety system that may be provided includes the provision of positively charged wire 16 on a separate layer below negatively charged wire 18 that would remain near the upper surface of the mat 2. The negatively charged layer of wire 18 may be oriented bridging the wire 16. Thereby, a fill material or other spacing device is provided to separate the wire 18 from the wire 16 until a certain amount of weight or pressure is applied on the mat to compress the spacers. Such spacers are shown by way of example in FIG. 4 of the illustrations. Once pressure is applied to negative wire 18 causing contact with positive wire 16, a circuit is made causing an electric shock to an animal standing on the mat 2 and having contact with wire 18 that remains on the upper surface of the mat 2. Otherwise, a person could stand on the mat 2 without contacting the lower layer of positively charged wire 16 and thus not receive as great a shock.

By using the mat 2 as described herein between the fence posts 8 of gate 6, livestock or animals are deterred from exiting through the open gate 6 of the otherwise confined area. Thus, using the methods described the integrity of the fenced area is maintained. The mat 2 is placed such that it spans a substantial portion of the length of the gate's 6 opening when a gate is left open. The mat 2 may be used with gates for driveways entering livestock pasture, gates for petting zoos, or wherever gates allow ingress and egress traffic to areas that confine animals and livestock. The mat 2 replaces the need for push gates and the like to confine livestock when a gate is open, and overcomes the inefficiencies in time and energy caused by opening and closing gates in that such gates may be left open when using the methods described in using the mat 2. Using the methods described in the invention, traffic may pass through an open gate where animals are confined without concern with whether the gate is closed after passage. Additionally, the use of mat 2 as described herein prevents the escape of livestock from confined areas when a gate 6 is left open saving still further time and trouble.

From the foregoing description of the illustrative embodiments of the invention, it will be apparent that many modifications may be made. The embodiments described exemplify the invention, and the invention is not limited thereto. Therefore, it is intended that the claims are to cover all such modifications that fall within the true spirit and scope of the invention.

I claim:

1. An apparatus for confining animals comprising:
an insulated substrate;
a electrically conductive medium embedded an acceptable depth in the substrate;
a power source coupled to the electrically conductive medium for supplying electrical current to the electrically conductive medium and providing for the electrically conductive medium to be grounded by a source not connected to the insulated substrate;
an activation device coupled to the power source for enabling activation of the power source; and
wherein a shock will be provided to an animal when the animal contacts the insulated substrate and the power source is activated.

2. An apparatus as in claim 1 wherein the activation device is a remote control unit.

3. An apparatus as in claim 1 wherein the apparatus includes an anchoring device for enabling the apparatus to be securely anchored to a ground.

4. An apparatus as in claim 1 wherein a warning device is attached to the activation device and the warning device alerts individuals that the power source is activated wherein the warning device acts as a safety feature.

5. An apparatus as in claim 1 wherein a variable adjusting device is coupled to the power source for varying electrical current supplied to the plurality of conductive wire.

6. An apparatus as in claim 1 wherein the power source is a solar power unit.

7. An apparatus as in claim 1 wherein the electrically conductive medium includes a plurality of conductive wire substantially aligned with the top surface of the insulated substrate.

8. An apparatus comprising:
a insulated substrate having a surface area of at least 16 square feet;
the substrate having a plurality of grooves;
a plurality of conductive wire is embedded an acceptable depth in the substrate so as to provide for the plurality of conductive wire to be substantially aligned with a top surface of the insulated substrate;
the plurality of wire is arranged in a grid fashion for providing the plurality of wires to be substantially parallel to one another;
a power source is coupled to the plurality of conductive wire for supplying current to the plurality of conductive wire;
an activation device is coupled to the power source for enabling activation of the power source; and
wherein a shock will be provided to an animal when the animal contacts the insulated substrate and the power source is activated.

9. An apparatus as in claim 8 wherein the conductive wire is electrically coupled to provide for the conductive wire to receive a positive charge.

10. An apparatus as in claim 8 wherein an alternating wire of the plurality of conductive wire is positively and negatively arranged.

11. An apparatus as in claim 8 wherein the plurality of conductive wire is alternatively arrange to provide for a first set and a second set, the first set is electrically coupled to the power source and the second set is coupled to a switch, the switch is coupled to the power source for enabling selecting of electrical arrangement of the plurality of conductive wire.

12. An apparatus as in claim 8 wherein the activation device is a remote control unit.

13. An apparatus as in claim 8 wherein the apparatus includes an anchoring device for enabling the apparatus to be securely anchored to a ground surface.

14. An apparatus as in claim 8 wherein a warning device is attached to the activation device and the warning device alerts individuals that the power source is activated wherein the warning device acts as a safety feature.

15. An apparatus as in claim 8 wherein the plurality of conductive wire constitutes a first set of conductive wire and a second set of a plurality of wires is located below the first set of the conductive wire and is supported via a plurality of spaced apart spacers, the spacers are fabricated from non-conductive material and includes compression capability and the second set is coupled to the power source, and wherein contact between the first set of conductive wire and the second set of conductive wire causes a closed circuit to form for shocking the animal.

16. A method of preventing the traverse of animals through a gate including the steps of:
a. providing a mat having an insulated substrate holding an electrically conductive medium;
b. coupling a power source to the conductive medium for supplying current through the conductive medium;
c. locating the mat in a location of the gate so as to enable normal operation of the gate;
d. activating the power source and wherein activation of the power source provides for current to travel through the conductive medium and will provide a shock to an animal that contacts the mat when attempting to exit the gate.

17. A method as in claim 16 further comprising the step of:
utilizing a remote activation device for activating the power source.

18. A method as in claim 16 further comprising the step of:
utilizing at least one additional mat in the location of the gate and the at least one additional mat being substantially identical to the mat and being approximately four feet in length so as to provide for a size that will accommodate any conventional gate and can be arranged in a side-by-side relationship for accommodating larger gates.

19. A method as in claim 16 further comprising the steps of:
utilizing at least two layers of conductive wires in the conductive medium forming a first set and a second set being located below the first set, the layers being separated by a compressible medium and forming a completed circuit when contact is made between the first set and the second set caused by an animal stepping on the mat when attempting to exit the gate.

20. A method of conditioning animals to prevent traverse through a gate including the steps of:
a. providing a mat having an insulated substrate holding an electrically conductive medium;
b. coupling a power source to the conductive medium for supplying current through the conductive medium;
C. locating the mat in a location of the gate so as to enable normal operation of the gate;
d. activating the power source and wherein activation of the power source provides for current to travel through the conductive medium and will provide a shock to an animal that contacts the mat when attempting to exit the gate;
e. deactivating the power source to the mat after the animal is conditioned, while the mat remains located in the location of the gate.
